(19) United States
(12) Patent Application Publication
(10) Pub. No.: US 2018/0196370 A1
(43) Pub. Date: Jul. 12, 2018

(54) INTEGRATED CIRCUIT, CALIBRATION SYSTEM, AND PRINTER

(71) Applicant: Yohichi INADA, Tokyo (JP)

(72) Inventor: Yohichi INADA, Tokyo (JP)

(73) Assignee: Ricoh Company, Ltd., Tokyo (JP)

(21) Appl. No.: 15/841,668

(22) Filed: Dec. 14, 2017

(30) Foreign Application Priority Data
Jan. 6, 2017 (JP) 2017-001035

(51) Int. Cl. G03G 15/00

(52) U.S. Cl. CPC G03G 15/0822; G03G 15/105

(57) ABSTRACT

An integrated circuit includes a memory, a selecting circuit, and a calibration processing circuit. The memory stores parameter sets for a plurality of color plates. The selecting circuit selects, from the stored parameter sets for the plurality of color plates, a parameter set corresponding to a color plate to be detected by a density sensor. The density sensor is at least one of a plurality of density sensors provided for a printer. The calibration processing circuit executes a print density calibration process on the color plate to be detected based on the selected parameter set corresponding to the color plate to be detected and a value of the color plate detected by the density sensor.

### CROSS-REFERENCE TO RELATED APPLICATION

This patent application is based on and claims priority pursuant to 35 U.S.C. § 119(a) to Japanese Patent Application No. 2017-001035 filed on Jan. 6, 2017, in the Japan Patent Office, the entire disclosure of which is hereby incorporated by reference herein.

### BACKGROUND

### Technical Field

The present invention relates to an integrated circuit, a calibration system, and a printer.

### Description of the Related Art

An existing printer such as a laser printer forms a toner image with cylindrical rotary members such as a photoconductor drum and a developing roller, and transfers the toner image onto a recording sheet to print an image in accordance with print data.

In such a printer, if any of the rotary members is eccentric or is not perfectly circular in section, uneven pressure is applied to the toner image in the transfer process, thereby causing uneven printing. To address the uneven printing, the printer may perform print density calibration based on a density value of the toner image detected by a sensor. Such print density calibration is desired to be performed at high speed, and thus is often implemented by an integrated circuit such as a large-scale integration (LSI) circuit.

### SUMMARY

In one embodiment of this invention, there is provided an improved integrated circuit that includes, for example, a memory, a selecting circuit, and a calibration processing circuit.

The memory stores parameter sets for a plurality of color plates. The selecting circuit selects, from the stored parameter sets for the plurality of color plates, a parameter set corresponding to a color plate to be detected by a density sensor. The density sensor is at least one of a plurality of density sensors provided for a printer. The calibration processing circuit executes a print density calibration process on the color plate to be detected based on the selected parameter set corresponding to the color plate to be detected and a value of the color plate detected by the density sensor.

In one embodiment of this invention, there is provided an improved calibration system for a printer. The calibration system includes, for example, the above-described integrated circuit, the plurality of density sensors, and a processor. The plurality of density sensors include the density sensor that detects the color plate. The processor previously writes the parameter sets for the plurality of color plates in the memory of the integrated circuit, and supplies color plate information to the integrated circuit. The color plate information represents correspondence between the density sensor and the color plate to be detected by the density sensor.

In one embodiment of this invention, there is provided an improved printer that includes, for example, an image forming device to form an image and the above-described calibration system.

In one embodiment of this invention, there is provided an improved integrated circuit that includes, for example, means for storing parameter sets for a plurality of color plates, means for selecting, from the stored parameter sets for the plurality of color plates, a parameter set corresponding to a color plate to be detected, and means for executing a print density calibration process on the color plate to be detected based on the selected parameter set corresponding to the color plate to be detected and a detected value of the color plate.

In one embodiment of this invention, there is provided an improved calibration system for a printer. The calibration system includes, for example, the above-described integrated circuit, means for detecting the color plate, in which the means for detecting is at least a density sensor of a plurality of a plurality of density sensors provided for a printer, and means for previously writing the parameter sets for the plurality of color plates in the means for storing of the integrated circuit, and supplying color plate information to the integrated circuit. The color plate information represents correspondence between the density sensor and the color plate to be detected by the density sensor.

In one embodiment of this invention, there is provided an improved printer that includes, for example, means for forming an image and the above-described calibration system.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a conceptual diagram illustrating an internal configuration of a printer of a first embodiment of the present invention;

FIG. 2 is a diagram illustrating a functional configuration of a calibration system of the printer of the first embodiment;

FIG. 3 is a flowchart illustrating a procedure of a process performed by the calibration system of the first embodiment;

FIG. 4 is a diagram illustrating a first example of calibration patterns detected by density sensors of the calibration system of the first embodiment;

FIG. 5 is a diagram illustrating a second example of the calibration patterns detected by the density sensors of the first embodiment;

FIG. 6 is a diagram illustrating a functional configuration of a calibration system of a second embodiment of the present invention;

FIG. 7 is a diagram illustrating an example of a color plate order list of the second embodiment; and

FIG. 8 is a diagram illustrating a functional configuration of a calibration system of a third embodiment of the present invention.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the accompanying drawings, wherein like reference numerals designate identical or corresponding parts throughout the several views, embodiments of the present invention will be described.

A configuration of a printer 100 according to a first embodiment of the present invention will be described.

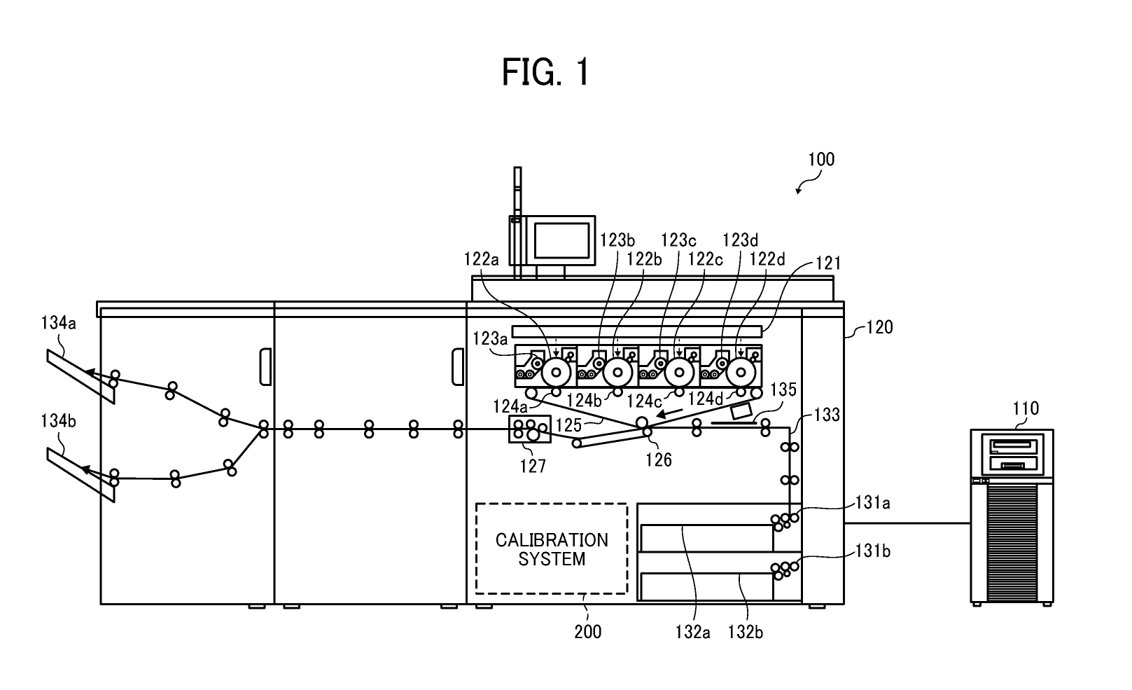

FIG. 1 is a conceptual diagram illustrating an internal configuration of the printer 100 of the first embodiment. The printer 100 illustrated in FIG. 1 includes a print server 110 and a main unit 120. The print server 110 stores print data, which is transmitted to the main unit 120 in response to an instruction from a user.

The main unit 120 includes an optical device 121, photoconductor drums 122a, 122b, 122c, and 122d, developing rollers 123a, 123b, 123c, and 123d, first transfer rollers 124a, 124b, 124c, and 124d, a transfer belt 125, a second transfer roller 126, a fixing device 127, transport devices 131a and 131b, sheet trays 132a and 132b, a transport path 133, sheet ejection trays 134a and 134b, and a recording sheet 135.

The main unit 120 processes the print data through processes such as color correction, density conversion, and conversion into fewer values to ultimately obtain binary print data, and transmits the binary print data to the optical device 121.

The optical device 121, which employs laser diodes, for example, as laser light sources, emits laser beams onto uniformly charged surfaces of the photoconductor drums 122a, 122b, 122c, and 122d in accordance with the print data.

With the laser beams emitted to the uniformly charged surfaces of the photoconductor drums 122a, 122b, 122c, and 122d in accordance with the print data, electric charge is lost in portions of the surfaces of the photoconductor drums 122a, 122b, 122c, and 122d irradiated with the laser beams. Thereby, latent images according to the print data are formed on the surfaces of the photoconductor drums 122a, 122b, 122c, and 122d. With the rotation of the photoconductor drums 122a, 122b, 122c, and 122d, the thus-formed latent images are moved to the respective corresponding developing rollers 123a, 123b, 123c, and 123d.

With the rotation of the developing rollers 123a, 123b, 123c, and 123d, toner supplied from respective corresponding toner cartridges adheres to surfaces of the developing rollers 123a, 123b, 123c, and 123d and then to the latent images formed on the surfaces of the photoconductor drums 122a, 122b, 122c, and 122d. Thereby, the latent images formed on the surfaces of the photoconductor drums 122a, 122b, 122c, and 122d are rendered visible as toner images formed on the surfaces of the photoconductor drums 122a, 122b, 122c, and 122d.

Between the photoconductor drums 122a, 122b, 122c, and 122d and the first transfer rollers 124a, 124b, 124c, and 124d, the toner images formed on the surfaces of the photoconductor drums 122a, 122b, 122c, and 122d are transferred onto the transfer belt 125. Thereby, toner images are formed on the transfer belt 125.

In the example illustrated in FIG. 1, the optical device 121, the photoconductor drums 122a, 122b, 122c, and 122d, the developing rollers 123a, 123b, 123c, and 123d, and the first transfer rollers 124a, 124b, 124c, and 124d are provided for four print colors: yellow (Y), cyan (C), magenta (M), and key plate (K). Thereby, toner images of the respective print colors are formed on the transfer belt 125.

Each of the transport devices 131a and 131b feeds the recording sheet 135 from a corresponding one of the sheet trays 132a and 132b to the transport path 133. The recording sheet 135 fed to the transport path 133 is transported to between the transfer belt 125 and the second transfer roller 126. Between the transfer belt 125 and the second transfer roller 126, therefore, the toner images of the respective print colors formed on the transfer belt 125 are transferred onto the recording sheet 135. Thereafter, the fixing device 127 applies heat and pressure to the recording sheet 135 to fix the toner images thereon. The recording sheet 135 is then transported to a designated one of the sheet ejection trays 134a and 134b.

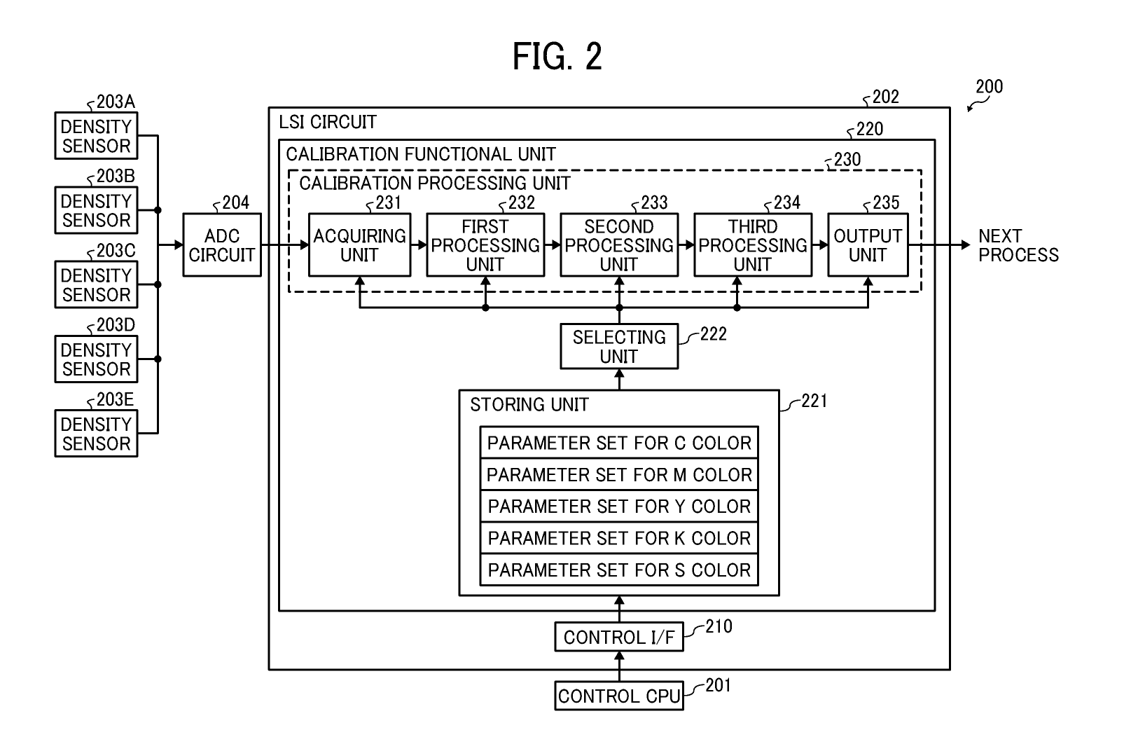

As illustrated in FIG. 1, the thus-configured printer 100 further includes a calibration system 200. The calibration system 200 performs print density calibration based on density values of calibration patterns detected by density sensors 203A, 203B, 203C, 203D, and 203E illustrated in FIG. 2. With this calibration, the printer 100 prevents uneven printing due to, for example, a defect of a rotary member such as the photoconductor drum 122a, 122b, 122c, or 122d or the developing roller 123a, 123b, 123c, or 123d. The calibration system 200 of the first embodiment is configured to specifically shorten the time taken for the print density calibration (hereinafter simply referred to as the calibration), as described in detail below.

A functional configuration of the calibration system 200 will now be described.

FIG. 2 is a diagram illustrating a functional configuration of the calibration system 200 of the first embodiment. As illustrated in FIG. 2, the calibration system 200 includes the density sensors 203A to 203E, a control central processing unit (CPU) 201, a large-scale integration (LSI) circuit 202, and an analog-to-digital converter (ADC) circuit 204. The LSI circuit 202 is an example of an integrated circuit of the present invention. The LSI circuit 202 includes a control interface (I/F) 210 and a calibration functional unit 220.

The density sensors 203A to 203E are provided at respective positions facing the transfer belt 125 to detect the density values of the calibration patterns transferred to the transfer belt 125. Data of the calibration patterns is included in the print data to form the calibration patterns on the transfer belt 125 between a toner image to be transferred onto a recording sheet 135 and a next toner image to be transferred onto a next recording sheet 135. The density values detected by the density sensors 203A to 203E are output to the calibration functional unit 220 of the LSI circuit 202 via the ADC circuit 204. The density sensors 203A to 203E employ photodiodes, for example.

The control CPU 201 is an example of a processor of the present invention. The control CPU 201 controls the calibration functional unit 220 of the LSI circuit 202 via the control I/F 210 the LSI circuit 202. For example, the control CPU 201 inputs a parameter write instruction to a storing unit 221 of the calibration functional unit 220. Thereby, the control CPU 201 previously writes parameter sets for the respective color plates in the storing unit 221. The term “previously” refers here to when there is a sufficient time for writing the parameter sets for the respective color plates before the start of the calibration process during startup of the printer 100 or standby for a print job, for example.

Further, in each execution of the calibration, the control CPU 201 supplies color plate information to the calibration functional unit 220. The color plate information represents the correspondence between the density sensors 203A to 203E and the color plates of the calibration patterns to be detected by the density sensors 203A to 203E. For example, when the printer 100 forms the calibration patterns on the transfer belt 125, a host controller transmits information of the calibration patterns to the control CPU 201, which then generates the color plate information based on the transmitted information. Alternatively, the host controller may provide the color plate information to the control CPU 201.

The control CPU 201 inputs the parameter write instruction to the storing unit 221 together with an address signal to specify a parameter write position in the storing unit 221. The control CPU 201 is thereby capable of rewriting only a particular one of the parameters stored in the storing unit 221.

The calibration functional unit 220 has a function of performing the print density calibration in the printer 100. The calibration functional unit 220 includes the storing unit 221 (i.e., a memory), a selecting unit 222 (i.e., a selecting circuit), and a calibration processing unit 230 (i.e., a calibration processing circuit).

The storing unit 221 stores the parameter sets for the respective color plates, which are previously written by the control CPU 201. In the example illustrated in FIG. 2, for instance, the storing unit 221 stores a parameter set for cyan (C) color, a parameter set for magenta (M) color, a parameter set for yellow (Y) color, a parameter set for key plate (K) color, and a parameter set for special (S) color. The S color refers to special color such as transparent or white color. For example, the S color may be transparent color applied onto a normal print to add gloss thereto, or may be white color applied to a base surface of the recording sheet 135 to form a whiter base surface.

Each of the parameter sets includes a variety of parameters, such as a reference voltage set to convert a density value into a toner adhesion amount, a speed set for a corresponding one of the photoconductor drums 122a, 122b, 122c, and 122d, the number of data items to be calibrated, the number of executions of the calibration, a set effective image position, and a variety of correction coefficients, for example.

Based on the color plate information supplied by the control CPU 201, the selecting unit 222 selects, for each of the density sensors 203A to 203E, the parameter set corresponding to the color plate to be detected thereby (the C, M, Y, K, or S color plate, for example) from the parameter sets for the respective color plates stored in the storing unit 221. The selecting unit 222 then sets the parameter set selected for the each of the density sensors 203A to 203E in the calibration processing unit 230.

In each execution of the calibration, the selecting unit 222 reselects, for each of the density sensors 203A to 203E, the parameter set corresponding to the color plate to be detected thereby from the parameter sets for the respective color plates stored in the storing unit 221. The selecting unit 222 then sets the parameter set reselected for the each of the density sensors 203A to 203E in the calibration processing unit 230. If the color plate to be detected is unchanged for at least one of the density sensors 203A to 203E since the last execution of the calibration, the selecting unit 222 may not reselect the parameter set corresponding to the color plate to be detected.

The calibration processing unit 230 executes steps of the calibration process. For example, the calibration processing unit 230 calculates the respective toner amounts of the calibration patterns transferred to the transfer belt 125 based on the density values of the calibration patterns output by the density sensors 203A to 203E. The calibration processing unit 230 then compares the calculated toner amounts with desired toner amount values to determine the level of print density. The calibration processing unit 230 further adjusts the level of print density in accordance with the determined level of print density. For example, the calibration processing unit 230 adjusts the amounts of laser beams output by the optical device 121 or the charge amounts of the photoconductor drums 122a, 122b, 122c, and 122d to adjust the level of print density. The calibration processing unit 230 thereby prevents uneven printing of the printer 100.

In the example illustrated in FIG. 2, the calibration processing unit 230 includes an acquiring unit 231, a first processing unit 232, a second processing unit 233, a third processing unit 234, and an output unit 235. For example, the acquiring unit 231 acquires the density value output by the density sensor 203A via the ADC circuit 204 in accordance with a data acquisition amount included in the parameter set set for the density sensor 203A. Further, for example, the first processing unit 232 converts the toner adhesion amount of the color plate detected by the density sensor 203A into a numerical value based on the density value detected and output by the density sensor 203A and acquired by the acquiring unit 231 and the set reference voltage included in the parameter set set for the density sensor 203A. Further, for example, based on a variety of determination values included in the parameter set set for the density sensor 203A, the output unit 235 determines the validity of the acquired data of the color plate detected by the density sensor 203A, and outputs valid data of the acquired data.

For each of the density sensors 203A to 203E, the calibration processing unit 230 (i.e., the acquiring unit 231, the first processing unit 232, the second processing unit 233, the third processing unit 234, and the output unit 235) performs the calibration process on the color plate to be detected by the each of the density sensors 203A to 203E based on the density value detected thereby and the parameter set set therefor by the selecting unit 222 (i.e., the parameter set corresponding to the color plate to be detected by the each of the density sensors 203A to 203E).

For example, if the density sensor 203A detects the C color plate, the selecting unit 222 selects for the density sensor 203A the parameter set corresponding to the C color plate from the parameter sets for the respective color plates stored in the storing unit 221. The selecting unit 222 then sets for the density sensor 203A the parameter set corresponding to the C color plate in the calibration processing unit 230, i.e., in each of the acquiring unit 231, the first processing unit 232, the second processing unit 233, the third processing unit 234, and the output unit 235.

The calibration processing unit 230 performs the calibration process on the C color plate based on the density value of the C color plate detected by the density sensor 203A and the parameter set corresponding to the C color plate set for the density sensor 203A.

Also for each of the other density sensors 203B to 203E, the calibration processing unit 230 similarly performs the calibration process based on the density value detected by the each of the density sensors 203B to 203E and the parameter set set for the each of the density sensors 203B to 203E. The calibration processing unit 230 thereby prevents uneven printing of the printer 100.

A procedure of a process performed by the calibration system 200 will now be described.

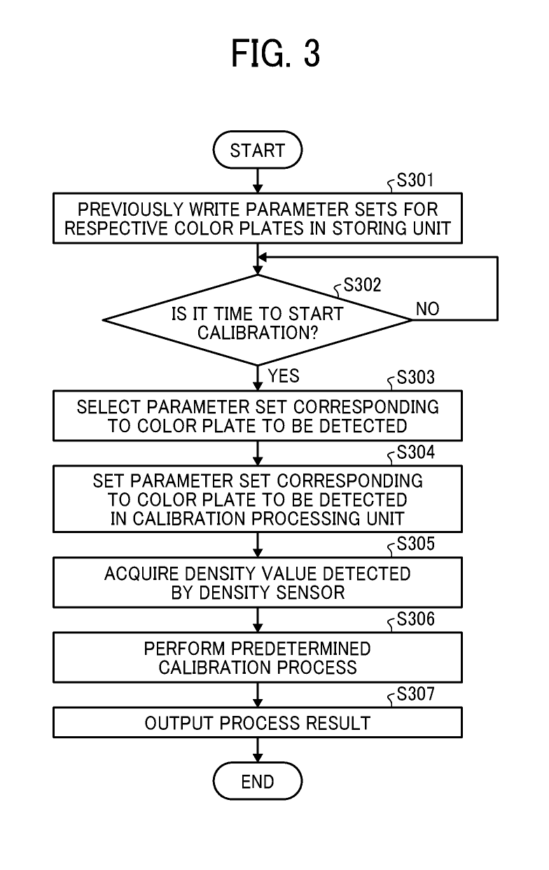

FIG. 3 is a flowchart illustrating a procedure of a process performed by the calibration system 200 of the first embodiment.

Firstly, the control CPU 201 previously writes the parameter sets for the respective color plates in the storing unit 221 (step S301). Thereafter, the calibration functional unit 220 determines whether it is time to start the calibration (step S302).

If the calibration functional unit 220 determines at step S302 that it is not time to start the calibration (NO at step S302), the calibration functional unit 220 re-executes the process of step S302.

If the calibration functional unit 220 determines at step S302 that it is time to start the calibration (YES at step S302), the selecting unit 222 selects, for each of the density sensors 203A to 203E, the parameter set corresponding to the color plate to be detected thereby from the parameter sets for the respective color plates stored in the storing unit 221 based on the color plate information supplied by the control CPU 201 (step S303). Then, for each of the density sensors 203A to 203E, the selecting unit 222 sets the parameter set selected at step S303, i.e., the parameter set corresponding to the color plate to be detected by the each of the density sensors 203A to 203E, in the calibration processing unit 230 (step S304).

Thereafter, the acquiring unit 231 acquires the density values detected by the density sensors 203A to 203E (step S305). With the density values of the density sensors 203A to 203E acquired at step S305 and the parameter sets set for the density sensors 203A to 203E at step S304, each of the first processing unit 232, the second processing unit 233, and the third processing unit 234 performs a predetermined calibration process (step S306). Then, the output unit 235 outputs the result of the predetermined calibration process (step S307), and the calibration system 200 completes the steps of the process illustrated in FIG. 3.

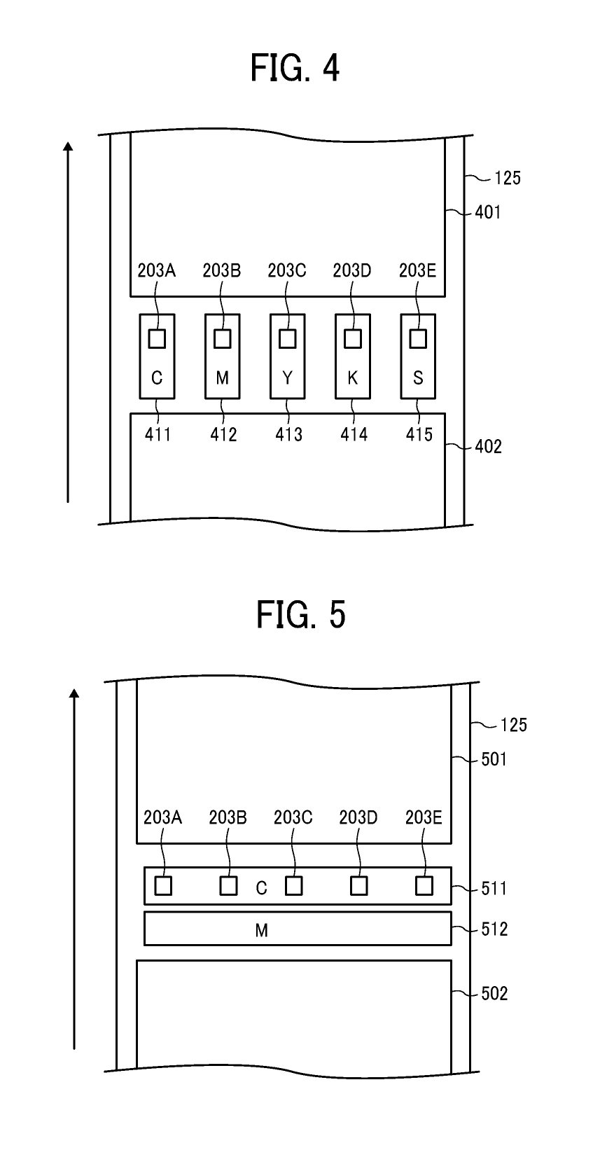

FIG. 4 is a diagram illustrating a first example of the calibration patterns detected by the density sensors 203A to 203E of the first embodiment. In the example illustrated in FIG. 4, calibration patterns 411, 412, 413, 414, and 415 are formed on the transfer belt 125 between a toner image 401 to be transferred onto a recording sheet 135 and a next toner image 402 to be transferred onto a next recording sheet 135 such that the calibration patterns 411 to 415 are aligned in a lateral direction in FIG. 4 perpendicular to a transport direction of the transfer belt 125 indicated by an arrow in FIG. 4. The C color plate, the M color plate, the Y color plate, the K color plate, and the S color plate are employed in the calibration patterns 411, 412, 413, 414, and 415, respectively. Further, the density sensors 203A, 203B, 203C, 203D, and 203E are disposed at respective positions at which the density sensors 203A, 203B, 203C, 203D, and 203E are capable of detecting the calibration patterns 411, 412, 413, 414, and 415, respectively.

In the calibration process using the above-described calibration patterns 411 to 415, the control CPU 201 first supplies the calibration functional unit 220 with the color plate information representing the correspondence between the density sensors 203A, to 203E and the color plates to be detected thereby. In the example of FIG. 4, for instance, the color plate information indicates that the C color plate, the M color plate, the Y color plate, the K color plate, and the S color plate are to be detected by the density sensors 203A, 203B, 203C, 203D, and 203E, respectively.

Based on this color plate information, the selecting unit 222 selects, for each of the density sensors 203A to 203E, the parameter set corresponding to the color plate to be detected thereby from the parameter sets for the respective color plates stored in the storing unit 221. The selecting unit 222 then sets the parameter set selected for the each of the density sensors 203A to 203E in the calibration processing unit 230.

Accordingly, the calibration processing unit 230 is capable of executing an appropriate calibration process on each of the density sensors 203A to 203E with an appropriate parameter set according to the color plate to be detected thereby.

In this case, the information downloaded into the calibration functional unit 220 from the control CPU 201 is only the color plate information, the data amount of which is small. In the existing printer, a variety of parameters according to the number of density sensors need to be downloaded en masse into the integrated circuit in each execution of the calibration process. According to the first embodiment, on the other hand, the information downloaded into the calibration functional unit 220 in this case is only the color plate information having the small data amount. Accordingly, the calibration system 200 of the first embodiment is capable of setting the parameters in the calibration processing unit 230 in a short period of time.

FIG. 5 is a diagram illustrating a second example of the calibration patterns detected by the density sensors 203A to 203E of the first embodiment. In the example illustrated in FIG. 5, calibration patterns 511 and 512 are formed on the transfer belt 125 between a toner image 501 to be transferred onto a recording sheet 135 and a next toner image 502 to be transferred onto a next recording sheet 135 such that the calibration patterns 511 and 512 are aligned in a longitudinal direction in FIG. 5, which corresponds to the transport direction of the transfer belt 125 indicated by an arrow in the drawing. Each of the calibration patterns 511 and 512 has a rectangular shape, the longitudinal direction of which corresponds to the lateral direction in FIG. 5 perpendicular to the transport direction of the transfer belt 125.

The density sensors 203A to 203E are aligned along the longitudinal direction of the calibration patterns 511 and 512 corresponding to the lateral direction in FIG. 5. With this configuration, the density sensors 203A to 203E are capable of simultaneously detecting each of the calibration patterns 511 and 512.

In the calibration process using the calibration patterns 511 and 512, the control CPU 201 first supplies the calibration functional unit 220 with the color plate information of the first calibration pattern, i.e., the calibration pattern 511. In the example of FIG. 5, for instance, the color plate information of the calibration pattern 511 indicates that the C color plate is to be detected by each of the density sensors 203A to 203E.

Based on this color plate information, the selecting unit 222 selects, for each of the density sensors 203A to 203E, the parameter set corresponding to the C color plate from the parameter sets for the respective color plates stored in the storing unit 221. The selecting unit 222 then sets the parameter set selected for the each of the density sensors 203A to 203E in the calibration processing unit 230.

Accordingly, the calibration processing unit 230 is capable of executing an appropriate calibration process on each of the density sensors 203A to 203E with an appropriate parameter set according to the C color plate to be detected thereby.

The control CPU 201 then supplies the calibration functional unit 220 with the color plate information of the second calibration pattern, i.e., the calibration pattern 512. In the example of FIG. 5, for instance, the color plate information of the calibration pattern 512 indicates that the M color plate is to be detected by each of the density sensors 203A to 203E.

Based on this color plate information, the selecting unit 222 selects, for each of the density sensors 203A to 203E, the parameter set corresponding to the M color plate from the parameter sets for the respective color plates stored in the storing unit 221. The selecting unit 222 then sets the parameter set selected for the each of the density sensors 203A to 203E in the calibration processing unit 230.

Accordingly, the calibration processing unit 230 is capable of executing an appropriate calibration process on each of the density sensors 203A to 203E with an appropriate parameter set according to the M color plate to be detected thereby.

In this case, during the time between the calibration process using the calibration pattern 511 and the calibration process using the calibration pattern 512, the information downloaded into the calibration functional unit 220 from the control CPU 201 is only the color plate information of the calibration pattern 512, the data amount of which is small. In the existing printer, a variety of parameters according to the number of density sensors need to be downloaded en masse onto the integrated circuit in each execution of the calibration process. According to the first embodiment, on the other hand, the information downloaded into the calibration functional unit 220 in this case is only the color plate information of the calibration pattern 512 having the small data amount. After the completion of the calibration process using the calibration pattern 511, therefore, the calibration system 200 of the first embodiment is capable of setting the parameters for the calibration process using the calibration pattern 512 in a short period of time. Accordingly, the calibration system 200 of the first embodiment is capable of reducing the interval between the calibration patterns 511 and 512.

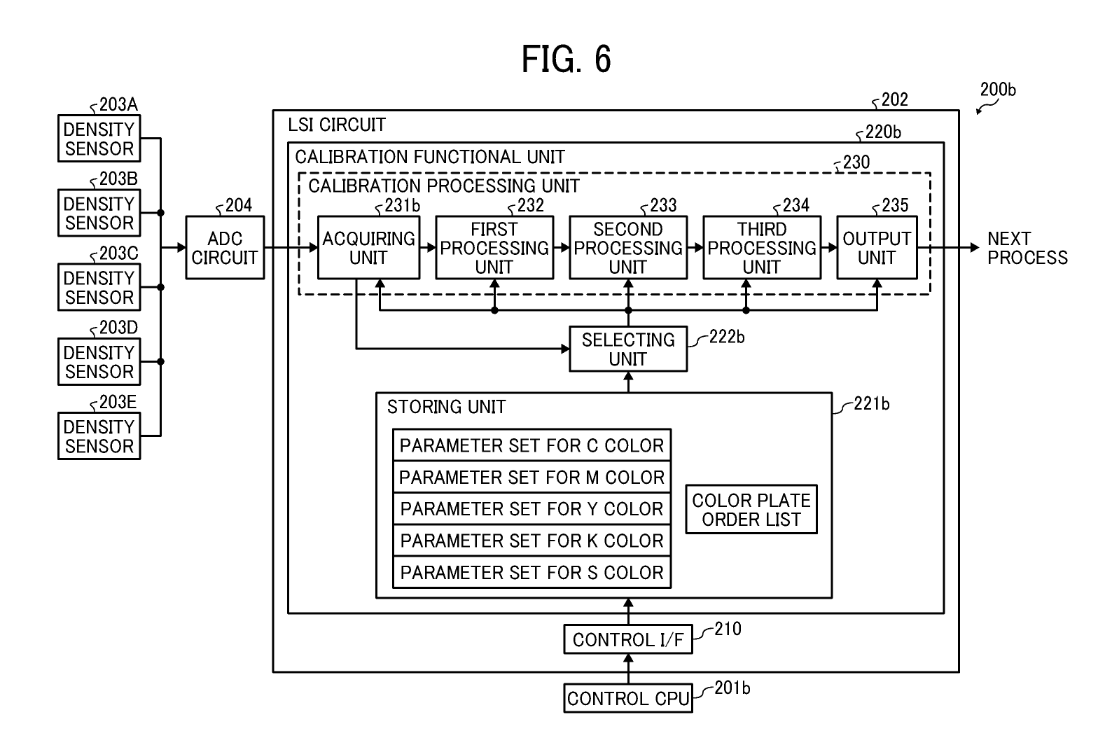

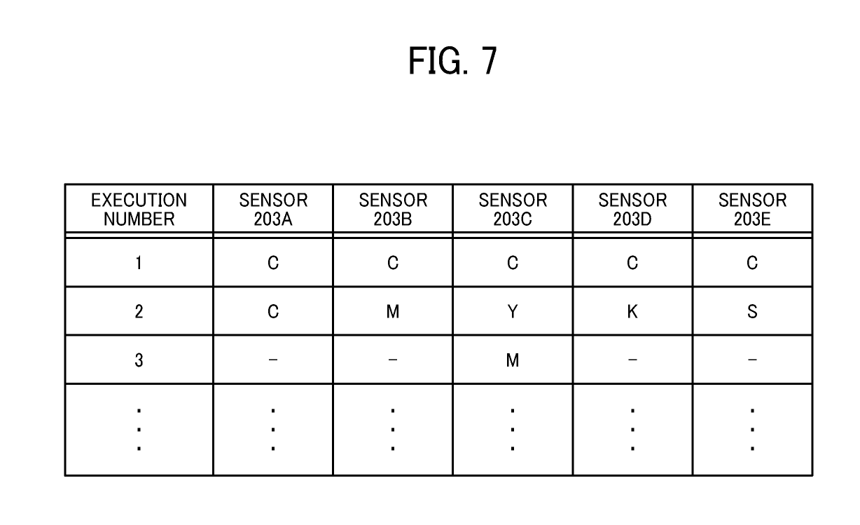

A second embodiment of the present invention will now be described with reference to FIGS. 6 and 7. The following description of the second embodiment will be given of differences from the first embodiment, and parts similar in function to those of the first embodiment will be designated with the same reference numerals as those used in the first embodiment, and description of such parts will be omitted.

A functional configuration of a calibration system 200b of the second embodiment will first be described.

FIG. 6 is a diagram illustrating a functional configuration of the calibration system 200b of the second embodiment. The calibration system 200b illustrated in FIG. 6 is different from the calibration system 200 illustrated in FIG. 2 in that the calibration system 200b includes a control CPU 201b and a calibration functional unit 220b in place of the control CPU 201 and the calibration functional unit 220. The calibration functional unit 220b is different from the calibration functional unit 220 illustrated in FIG. 2 in that the calibration functional unit 220b includes a storing unit 221b, a selecting unit 222b, and an acquiring unit 231b in place of the storing unit 221, the selecting unit 222, and the acquiring unit 231.

The control CPU 201b previously writes a color plate order list in the storing unit 221b. The color plate order list lists the color plates to be detected by the density sensors 203A to 203E such that the color plates are listed for each of executions of the calibration process arranged in execution order. Accordingly, the storing unit 221b previously stores the color plate order list. For example, in the printer 100, the control CPU 201b previously receives a calibration pattern generation schedule from the host controller, and generates the color plate order list based on the calibration pattern generation schedule. Alternatively, the control CPU 201b may receive the color plate order list from the host controller.

In each execution of the calibration, the selecting unit 222b refers to the color plate order list stored in the storing unit 221b, and thereby identifies the color plate to be detected by each of the density sensors 203A to 203E and reselects the parameter set corresponding to the identified color plate to be detected thereby. For example, the selecting unit 222b receives the number of executions of the calibration process from the acquiring unit 231b to identify how many times the calibration process has been executed before the next execution of the calibration process. Then, the selecting unit 222b refers to the color plate order list to reselect, for each of the density sensors 203A to 203E, the parameter set to be used in the identified next execution of the calibration process. The selecting unit 222b then sets the parameter set reselected for the each of the density sensors 203A to 203E in the calibration processing unit 230.

An example of the color plate order list will now be described.

FIG. 7 is a diagram illustrating an example of the color plate order list of the second embodiment. As illustrated in FIG. 7, the color plate order list indicates, for each of executions of the calibration process listed in the execution order, the color plate to be detected by each of the density sensors 203A to 203E. The color plate order list is previously stored in the storing unit 221b.

In the example illustrated in FIG. 7, for instance, the C color plate is set for each of the density sensors 203A to 203E in an execution of the calibration process assigned with execution number 1. Further, in an execution of the calibration process assigned with execution number 2, the C color plate, the M color plate, the Y color plate, the K color plate, and the S color plate are set for the density sensors 203A, 203B, 203C, 203D, and 203E, respectively. Further, in an execution of the calibration process assigned with execution number 3, the M color plate is set only for the density sensor 203C.

In the execution of the calibration process assigned with execution number 1 in this case, the selecting unit 222b selects from the storing unit 221b the parameter set corresponding to the C color plate for each of the density sensors 203A to 203E. Further, in the execution of the calibration process assigned with execution number 2, the selecting unit 222b reselects from the storing unit 221b the parameter set corresponding to the C color plate, the parameter set corresponding to the M color plate, the parameter set corresponding to the Y color plate, the parameter set corresponding to the K color plate, and the parameter set corresponding to the S color plate for the density sensors 203A, 203B, 203C, 203D, and 203E, respectively. In this process, the color plate to be detected by the density sensor 203A is unchanged. Thus, the selecting unit 222b may not reselect the parameter set for the density sensor 203A. Further, in the execution of the calibration process assigned with execution number 3, the selecting unit 222b reselects from the storing unit 221b the parameter set corresponding to the M color plate only for the density sensor 203C.

According to the calibration system 200b of the second embodiment, the color plate order list stored in the storing unit 221b is referred to reselect the parameter set corresponding to each of the density sensors 203A to 203E to be used in the next execution of the calibration process. According to the calibration system 200b, therefore, there is no need to download the color plate information in each execution of the calibration process, thereby shortening the processing time taken for changing the settings of the calibration process. Accordingly, the calibration system 200b enables consecutive executions of the calibration process at short processing intervals.

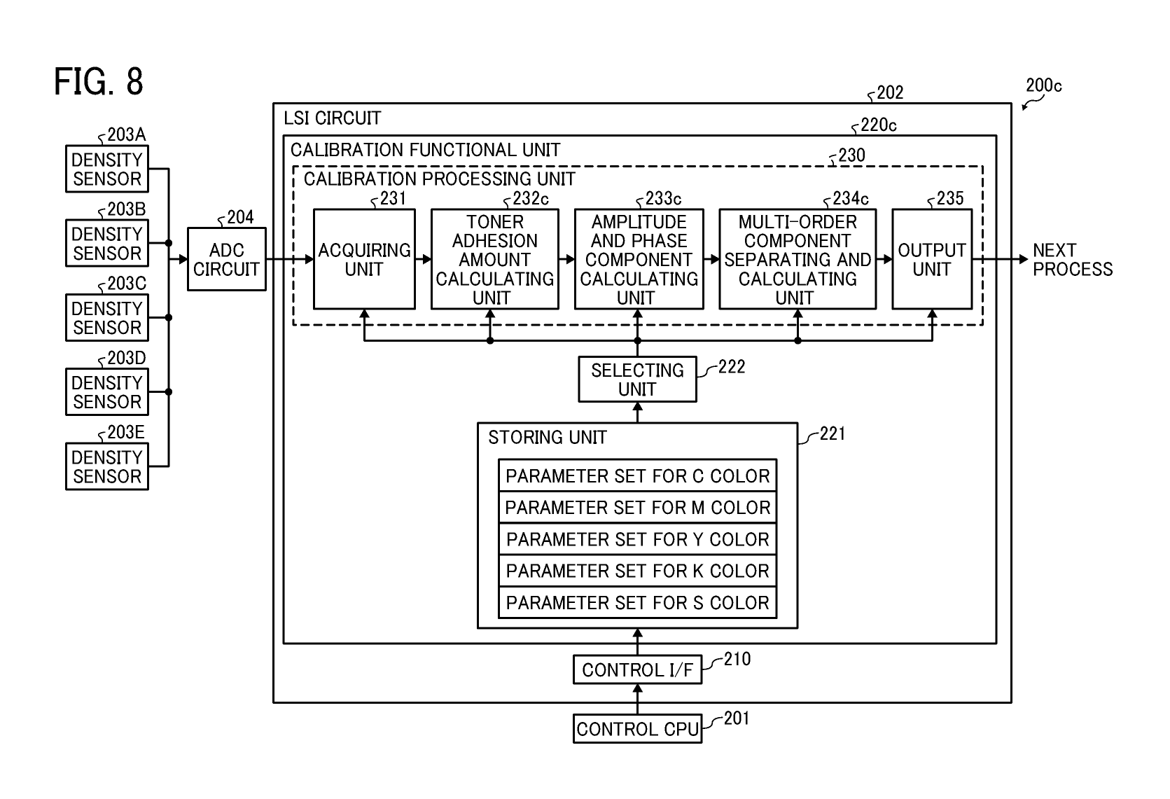

A third embodiment of the present invention will now be described with reference to FIG. 8. The following description of the third embodiment will be given of differences from the first embodiment, and parts similar in function to those of the first embodiment will be designated with the same reference numerals as those used in the first embodiment, and description of such parts will be omitted.

A functional configuration of a calibration system 200c of the third embodiment will be described.

FIG. 8 is a diagram illustrating a functional configuration of the calibration system 200c of the third embodiment. The calibration system 200c illustrated in FIG. 8 is different from the calibration system 200 illustrated in FIG. 2 in that the calibration system 200c includes a calibration functional unit 220c in place of the calibration functional unit 220. The calibration functional unit 220c is different from the calibration functional unit 220 illustrated in FIG. 2 in that the calibration functional unit 220c includes a toner adhesion amount calculating unit 232c (i.e., a toner adhesion amount calculating circuit), an amplitude and phase component calculating unit 233c (i.e., an amplitude and phase component calculating circuit), and a multi-order component separating and calculating unit 234c (i.e., a multi-order component separating and calculating circuit) in place of the first processing unit 232, the second processing unit 233, and the third processing unit 234.

Based on the density value of each of the density sensors 203A to 203E acquired by the acquiring unit 231, the toner adhesion amount calculating unit 232c calculates the toner amount of the corresponding calibration pattern actually transferred to the transfer belt 125.

The amplitude and phase component calculating unit 233c calculates amplitude and phase components related to the toner amount calculated by the toner adhesion amount calculating unit 232c. The amplitude and phase components calculated by the amplitude and phase component calculating unit 233c represent the extent of contribution of the toner amount to periodically occurring density unevenness.

The multi-order component separating and calculating unit 234c separates the amplitude and phase components calculated by the amplitude and phase component calculating unit 233c into multi-order amplitude and phase components. The multi-order amplitude and phase components obtained by the multi-order component separating and calculating unit 234c represent density unevenness caused by a plurality of mechanical mechanisms, such as the photoconductor drums 122a, 122b, 122c, and 122d and the developing rollers 123a, 123b, 123c, and 123d. The output unit 235 outputs necessary components of the results of the above-described calculations. The thus-output components are used in the next process and reflected in print parameters for the next printing process.

The calculation process of the amplitude and phase component calculating unit 233c and the separation process of the multi-order component separating and calculating unit 234c may be performed with existing techniques.

According to the calibration system 200c of the third embodiment, the calibration process includes the process of calculating the amplitude and phase components and the process of separating the amplitude and phase components, both of which involve a large number of parameters. According to the calibration system 200c, therefore, the processing time taken for changing the settings of the calibration process is further shortened.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Further, the above-described steps are not limited to the order disclosed herein.

1. An integrated circuit comprising:
a memory to store parameter sets for a plurality of color plates;
a selecting circuit to select, from the stored parameter sets for the plurality of color plates, a parameter set corresponding to a color plate to be detected by a density sensor, the density sensor being at least one of a plurality of density sensors provided for a printer; and
a calibration processing circuit to execute a print density calibration process on the color plate to be detected based on the selected parameter set corresponding to the color plate to be detected and a value of the color plate detected by the density sensor.

2. The integrated circuit of claim 1, wherein in each execution of the print density calibration process, the selecting circuit reselects the parameter set corresponding to the color plate to be detected from the stored parameter sets for the plurality of color plates.

3. The integrated circuit of claim 2, wherein the selecting circuit reselects the parameter set corresponding to the color plate to be detected based on a determination that the color plate to be detected is changed since a last execution of the print density calibration process.

4. The integrated circuit of claim 2, wherein the memory further stores a list of color plates to be detected, with the color plates listed for each of executions of the print density calibration process arranged in execution order, and
wherein in each execution of the print density calibration process, the selecting circuit refers to the list to identify the color plate to be detected and reselect the parameter set corresponding to the identified color plate to be detected.

5. The integrated circuit of claim 1, wherein the calibration processing circuit includes
a toner adhesion amount calculating circuit to calculate a toner usage amount from the value of the color plate detected by the density sensor,
an amplitude and phase component calculating circuit to calculate amplitude and phase components related to the calculated toner usage amount, and
a multi-order component separating and calculating circuit to separate the calculated amplitude and phase components into multi-order amplitude and phase components.

6. A calibration system for a printer, comprising:
the integrated circuit of claim 1;
the plurality of density sensors including the density sensor that detects the color plate; and
a processor to previously write the parameter sets for the plurality of color plates in the memory of the integrated circuit, and to supply color plate information to the integrated circuit, the color plate information representing correspondence between the density sensor and the color plate to be detected by the density sensor.

7. A printer comprising:
an image forming device to form an image; and
the calibration system of claim 6.

8. An integrated circuit comprising:
means for storing parameter sets for a plurality of color plates;
means for selecting, from the stored parameter sets for the plurality of color plates, a parameter set corresponding to a color plate to be detected; and
means for executing a print density calibration process on the color plate to be detected based on the selected parameter set corresponding to the color plate to be detected and a detected value of the color plate.

9. The integrated circuit of claim 8, wherein in each execution of the print density calibration process, the means for selecting reselects the parameter set corresponding to the color plate to be detected from the stored parameter sets for the plurality of color plates.

10. The integrated circuit of claim 9, wherein the means for selecting reselects the parameter set corresponding to the color plate to be detected based on a determination that the color plate to be detected is changed since a last execution of the print density calibration process.

11. The integrated circuit of claim 9, wherein the means for storing further stores a list of color plates to be detected, with the color plates listed for each of executions of the print density calibration process arranged in execution order, and
wherein in each execution of the print density calibration process, the means for selecting refers to the list to identify the color plate to be detected and reselect the parameter set corresponding to the identified color plate to be detected.

12. The integrated circuit of claim 8, wherein the means for executing includes
means for calculating a toner usage amount from the detected value of the color plate,
means for calculating amplitude and phase components related to the calculated toner usage amount, and
means for separating the calculated amplitude and phase components into multi-order amplitude and phase components.

13. A calibration system for a printer, comprising:
the integrated circuit of claim 8;
means for detecting the color plate, the means for detecting being at least a density sensor of a plurality of a plurality of density sensors provided for a printer; and
means for previously writing the parameter sets for the plurality of color plates in the means for storing of the integrated circuit, and supplying color plate information to the integrated circuit, the color plate information representing correspondence between the density sensor and the color plate to be detected by the density sensor.

14. A printer comprising:
means for forming an image; and
the calibration system of claim 13.
